(19) United States
(12) Patent Application Publication
(10) Pub. No.: US 2017/0085973 A1
(43) Pub. Date: Mar. 23, 2017

(54) AN AUDIO DEVICE

(71) Applicant: CHRIS SEARL PTY LTD, New South Wales (AU)

(72) Inventors: David JONES, New South Wales (AU); Stuart MAY, New South Wales (AU)

(73) Assignee: CHRIS SEARL PTY LTD, New South Wales (AU)

(21) Appl. No.: 15/312,341

(22) PCT Filed: May 19, 2015
(86) PCT No.: PCT/AU2015/050252

§ 371 Date: Nov. 18, 2016

(30) Foreign Application Priority Data
May 19, 2014 (AU) 2014901846

(51) Int. Cl. H04R 1/02; G09F 23/00; G09F 25/00

(52) U.S. Cl. CPC H04R 1/025; H04R 1/026; G09F 25/00; G09F 23/0058; H04R 2420/07

(57) ABSTRACT

An audio device that is usable at a point of sale location such as a refrigerator or a cabinet having a range of products. The audio device includes a body to be attached to an object that is to be moved by a person, for example the door of the refrigerator, and an electronic circuit mounted on the body. The electronic circuit includes an electrical power source, a speaker, a motion detector and a memory unit. The motion detector causes operation of the unit and speaker upon movement of the detector so that the speaker produces sound in accordance with information containing the memory unit.

### FIELD OF THE INVENTION

The present invention relates to audio devices and more particularly but not exclusively to audio devices that are usable at a point of sale location, such as a refrigerator or cabinet containing a range of products, with the view of providing information in respect of the products.

### BACKGROUND

At point of sale locations, such as in supermarkets, products are displayed in cabinets, including refrigerators and freezers. A shopper, upon opening the door of the cabinet, will view the product and then make a selection.

A disadvantage of point of sale displays is that information provided for the shopper is purely provided in a visual manner, by way of printed advertising. A disadvantage of visual presentations is that the shopper may see the information and may not be provided with sufficient information to make a choice.

### OBJECT OF THE INVENTION

It is the object of the present invention to overcome or substantially ameliorate the above disadvantage.

### SUMMARY OF THE INVENTION

There is disclosed herein an audio device including:
a body to be attached to an object that is to be moved by a person;
an electronic circuit mounted on the body, the circuit including an electrical power source, a speaker, a motion detector and a memory unit, with the motion detector causing operation of the unit and speaker upon movement of the detector so that the speaker produces sound in accordance with information containing the memory unit.

Preferably, the motion detector is an accelerometer.

Preferably, the power source is a rechargeable battery.

Preferably, the device is an IC device having a recorded message.

Preferably, the body includes a base to be fixed to the object, with the device including a module, containing the circuit, removably attached to the base.

Preferably, the battery is housed in the module, but is removable for recharging.

Preferably, the module can receive information wirelessly to provide for programming of the module.

In a further preferred form, the module can provide a wireless signal for the purposes of transmitting information.

### BRIEF DESCRIPTION OF THE DRAWINGS

Preferred forms of the present invention will now be described by way of example with reference to the accompanying drawings wherein:

FIG. 1 is a schematic isometric view of an audio device and a charging pad therefore;

FIG. 2 is a schematic isometric view of a plurality of audio devices in a charging pad therefore;

FIG. 3 is a schematic top plan view of the audio device of FIGS. 1 and 2;

FIG. 4 is a schematic bottom plan view of the audio device of FIGS. 1 and 2;

FIGS. 5 to 8 are schematic parts sectioned side elevations of the devices of FIGS. 3 and 4;

FIG. 9 is a schematic block diagram of the circuit of the device of FIGS. 3 and 4;

FIG. 10 is a schematic parts exploded isometric view of a modification of audio device of FIG. 1;

FIG. 11 is a further schematic isometric parts exploded view of the device of FIG. 10;

FIG. 12 is a schematic sectioned side elevation of the device of FIG. 10; and

FIG. 13 is a schematic block diagram of a circuit employed in the device of FIG. 10.

### DESCRIPTION OF EMBODIMENTS

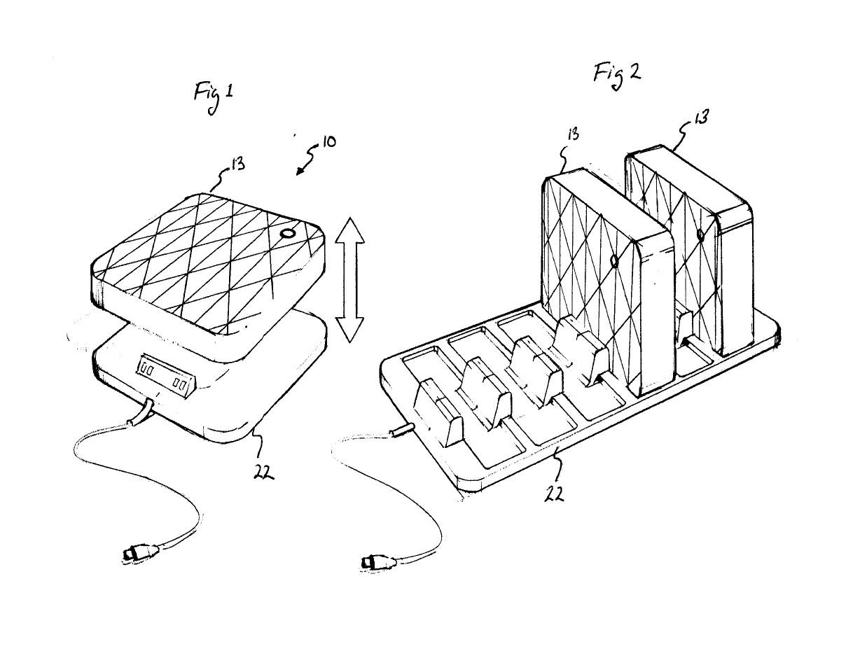

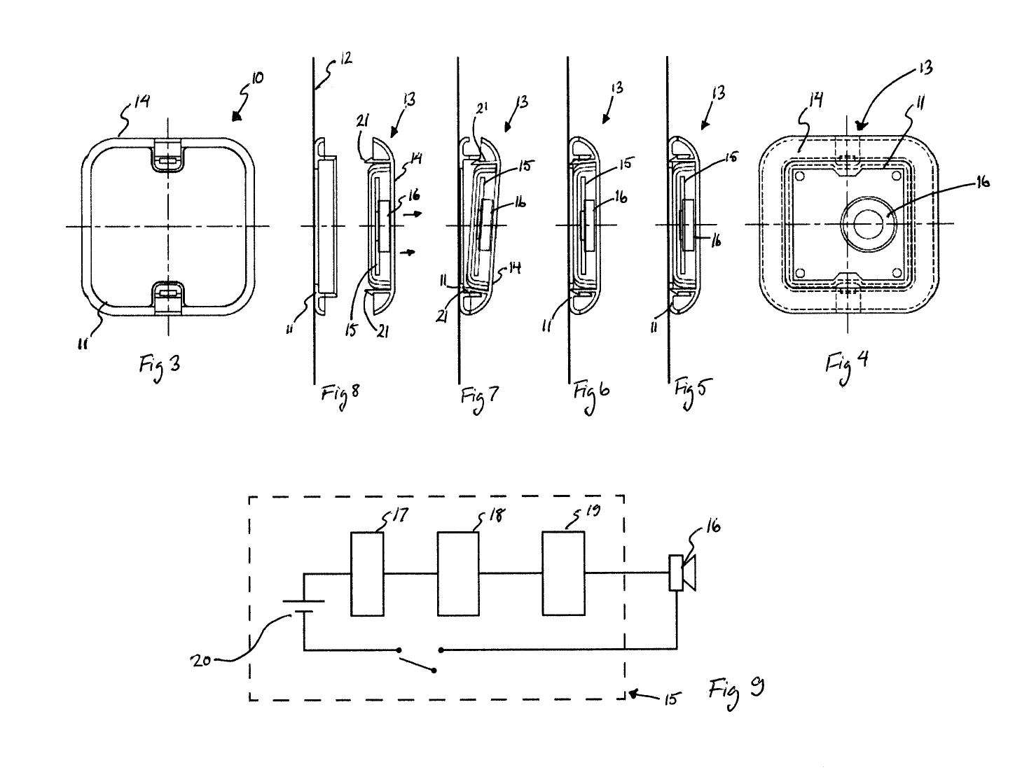

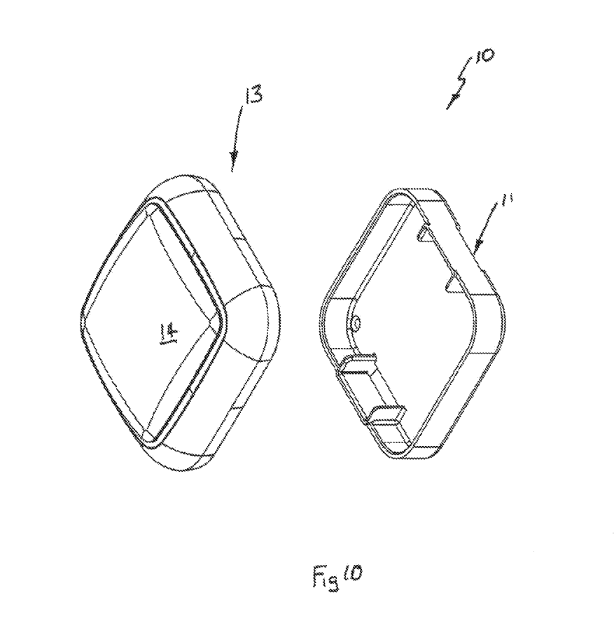

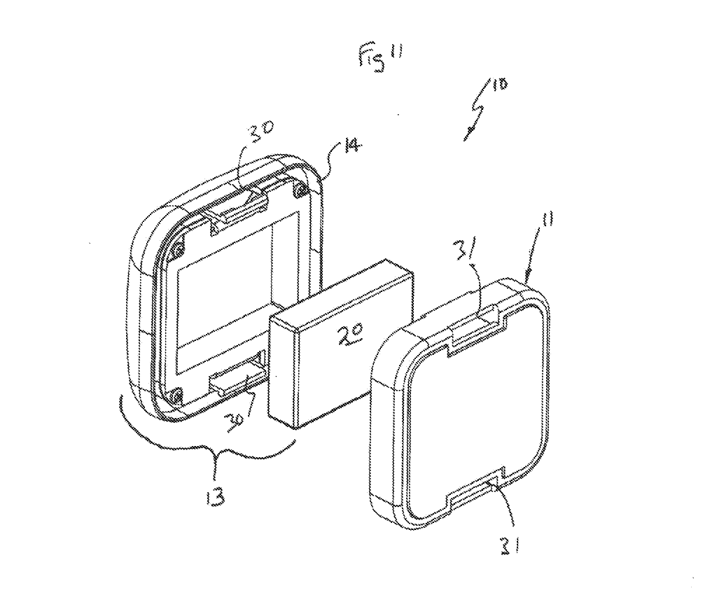

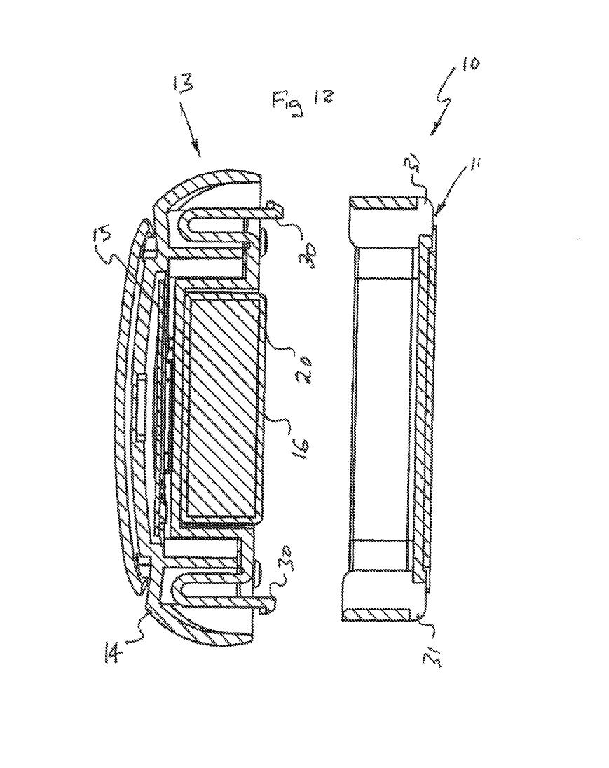

In FIGS. 1 to 9 of the accompanying drawings there is an audio device 10. The device 10 has a base 11 that is intended to be fixed to a door 12 of a cabinet, such as the display cabinet of a supermarket. The cabinet may be a refrigerator or freezer. As an example, the base 11 could be attached to the door 12 by an adhesive pad.

Detachably secured to the base 11 is a module 13, with the module 13 including a hollow body 14 containing a printed circuit board 15 and a speaker 16.

The printed circuit board 15 includes an accelerometer 17, a “de-bounce” circuit 18 and an integrated circuit device (unit) 19 that can store a recorded message.

Movement of the door 12 is detected by the accelerometer 17. Upon detection of movement the accelerometer 17 activates the IC device 19 so that the speaker 16 is activated to deliver the recorded message stored in the device 17. Preferably the board 15 and speaker 16 are powered by a rechargeable battery 20.

Preferably, the module 13 can be reprogrammed to change the message contained in the device 17.

Preferably, the body 14 is removably attached to the base 11 by resilient clips 21 that resiliently deform to provide for attachment and detachment of the module 13 with respect to the base 11.

The module 13 is recharged by being placed in a pad 22 that may receive one or more of the modules 13. The module 13 includes a manually operable switch 22.

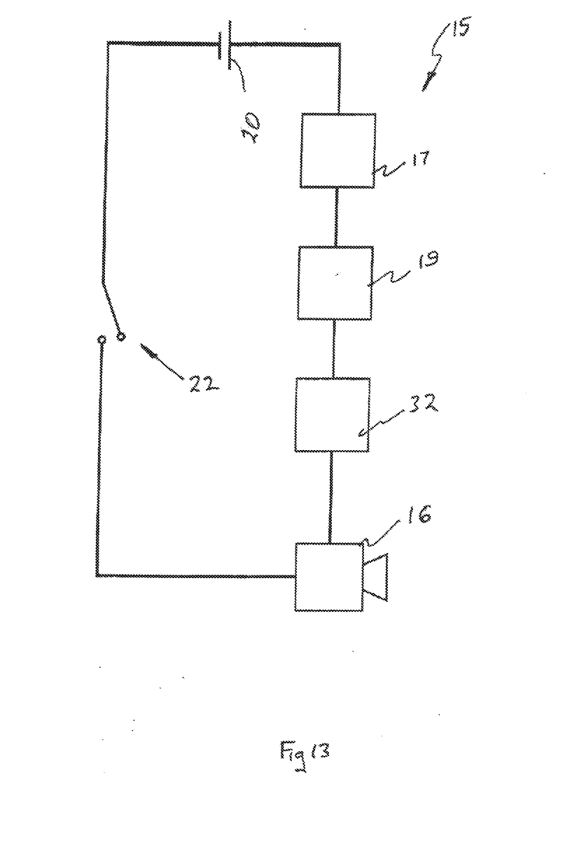

In the embodiment of FIGS. 10 to 13, body 14 is provided with resilient catch members 30 that resiliently deform and are urged into engagement in apertures 31 of the base 11 to secure the body 14 to the base 11.

Further in respect of this embodiment, the body 14 receives a removable/rechargeable battery 20.

In a further embodiment, the printed circuit board 15 would be provided by means enabling the board 15 to communicate wirelessly with a controller. As a particular example board 15 could receive signals for programming the integrated circuit device 19, such as to receive a new recorded message. In a further embodiment, the board 15 could be adapted to send wireless signals for the purposes of providing the controller with information. More specifically the board 15 would include a wireless communication device 32.

Preferably the speaker 16 is a polyphonic speaker.

The above described preferred embodiments provide a number of advantages, including being able to program the module 13 to deliver advertising via the speaker 16, when the door 12 is opened.

1. An audio device comprising:
a body to be attached to an object that is to be moved by a person; and
an electronic circuit mounted on the body, the circuit including an electrical power source, a speaker, a motion detector and a memory unit, with the motion detector causing operation of the unit and speaker upon movement of the detector so that the speaker produces sound in accordance with information containing the memory unit.

2. The audio device according to claim 1, wherein the motion detector is an accelerometer.

3. The audio device according to claim 1, wherein the power source is a rechargeable battery.

4. The audio device according to claim 1, wherein the device is an IC device having a recorded message.

5. The audio device according to claim 1, wherein the body includes a base to be fixed to the object, with the device including a module, containing the circuit, removably attached to the base.

6. The audio device according to claim 5, wherein the battery is housed in the module, but is removable for recharging.

7. The audio device according to claim 5, wherein the module can receive information wirelessly to provide for programming of the module.

8. The audio device according to claim 5, wherein, the module provides a wireless signal for the purposes of transmitting information.

9. The audio device according to claim 2, wherein the power source is a rechargeable battery.

10. The audio device according to claim 2, wherein the device is an IC device having a recorded message.

11. The audio device according to claim 3, wherein the device is an IC device having a recorded message.

12. The audio device according to claim 2, wherein the body includes a base to be fixed to the object, with the device including a module, containing the circuit, removably attached to the base.

13. The audio device according to claim 3, wherein the body includes a base to be fixed to the object, with the device including a module, containing the circuit, removably attached to the base.

14. The audio device according to claim 4, wherein the body includes a base to be fixed to the object, with the device including a module, containing the circuit, removably attached to the base.

15. The audio device according to claim 6, wherein the module can receive information wirelessly to provide for programming of the module.

16. The audio device according to claim 6, wherein, the module provides a wireless signal for the purposes of transmitting information.

17. The audio device according to claim 7, wherein, the module provides a wireless signal for the purposes of transmitting information.
